(19) United States
(12) Patent Application Publication
(10) Pub. No.: US 2026/0365555 A1
(43) Pub. Date: Nov. 19, 2026

(54) PURIFICATION OF EVAPORATOR CONDENSATE

(71) Applicant: LucasE3, L.C., Shawnee, KS (US)

(72) Inventor: Scott A. Lucas, De Soto, KS (US)

(21) Appl. No.: 19/676,419

(22) Filed: May 13, 2026

Related U.S. Application Data
(60) Provisional application No. 63/808,298, filed on May 19, 2025.

(51) Int. Cl. C02F 9/00; B01D 61/04; B01D 61/08; B01D 61/58; B01D 61/02; C02F 1/00; C02F 1/44; C02F 1/66; C02F 101/32; C02F 103/36

(52) U.S. Cl. CPC C02F 9/00; B01D 61/04; B01D 61/08; B01D 61/58; B01D 61/026; B01D 2311/04; C02F 1/004; C02F 1/441; C02F 1/66; C02F 2101/32; C02F 2103/36; C02F 2301/08

(57) ABSTRACT

Systems, methods, and devices for purifying evaporator condensate from one or more evaporators, such as evaporators of an ethanol distillation process. The evaporator condensate is fed to one or more separators to remove at least a portion of contaminants from the evaporator condensate. The one or more separators include at least one reverse osmosis system for removing at least a portion of the contaminants from the evaporator condensate to form a clean water stream. The clean water stream is then recycled to one or more systems of an ethanol distillation process that utilize clean water.

### RELATED APPLICATIONS

This non-provisional patent application claims priority benefit, with regard to all common subject matter, of earlier-filed U.S. Provisional Patent Application No. 63/808,298, filed on May 19, 2025, and entitled " PURIFICATION OF EVAPORATOR CONDENSATE." The identified earlier-filed provisional patent application is hereby incorporated by reference in its entirety into the present application.

### BACKGROUND

### 1. Field

Embodiments of the present disclosure generally relate to the purification of evaporator condensate. More specifically, embodiments of the present disclosure relate to the purification of evaporator condensate using one or more separation systems to remove one or more contaminants from the evaporator condensate.

### 2. Related Art

Ethanol distillation processes recover ethanol by fermenting organic feedstocks, such as corn, wheat, barley, soy, beans, milo, and other grains, to produce beer — a mixture primarily comprising ethanol, water, and solids. The beer is distilled to separate ethanol from the remaining mixture, known as whole stillage, which contains water, liquids, and solids. Whole stillage is typically processed through various separation techniques to recover byproducts. For example, a centrifuge may separate whole stillage into wet distillers grains and thin stillage, where thin stillage refers to the liquid fraction containing water, dissolved solids, and fine suspended particles. Thin stillage is often sent to evaporators to concentrate its components by removing water, thereby recovering an oil byproduct and producing a water recycle stream. The water recycle stream is generally reused at the beginning of the ethanol production process to mix with organic feedstocks and form a slurry. However, the water recycle stream typically contains contaminants such as organic acids, oils, alcohols, and solids, which limit its use in other parts of the distillation facility. For instance, systems such as carbon dioxide scrubbers and cooling towers require clean water for proper operation. If contaminated water is used, scum and other foulants accumulate, leading to frequent shutdowns and cleaning cycles. Accordingly, current ethanol distillation processes lack effective techniques for producing a clean water recycle stream that can be used in systems requiring high water purity.

### SUMMARY

Embodiments of the present disclosure solve the above-mentioned problems by providing systems and methods for purifying evaporator condensate from an ethanol distillation process. In particular, embodiments of the present disclosure include a process comprising one or more separators for removing one or more contaminants from the evaporator condensate to produce a clean water stream that can be utilized in carbon dioxide scrubbers and/or cooling towers of ethanol distillation processes. Accordingly, embodiments of the present disclosure provide a system and method that reduces the freshwater input of an ethanol distillation proves and the cost associated with freshwater compared to previous ethanol distillation processes.

In some embodiments, the techniques described herein relate to a process for purifying evaporator condensate including water, solids, oils, and organic acids, the process including: feeding the evaporator condensate to a pre-strainer to remove at least a first portion of the solids to form a membrane feed stream and a pre-strainer reject stream including the at least the first portion of the solids; feeding the membrane feed stream to a membrane system to remove at least a second portion of the oils to form a membrane permeate stream and a membrane retentate stream including the at least the second portion of the oils; feeding the membrane permeate stream to a first reverse osmosis system to remove at least a third portion of the organic acids from the membrane permeate stream to form a first reverse osmosis permeate stream and a first reverse osmosis retentate stream including the at least the third portion of the organic acids; adjusting a pH of the first reverse osmosis retentate stream to form a pH adjusted stream; and feeding the pH adjusted stream to a second reverse osmosis system to remove at least a fourth portion of the organic acids from the pH adjusted stream to form a clean water stream and a second reverse osmosis retentate stream including the at least the fourth portion of the organic acids.

In some embodiments, the techniques described herein relate to a process, wherein adjusting the pH of the first reverse osmosis retentate stream includes adding a basic material to the first reverse osmosis retentate stream to form the pH adjusted stream.

In some embodiments, the techniques described herein relate to a process, wherein the pH of the pH adjusted stream is within a range of 6 to 8.

In some embodiments, the techniques described herein relate to a process, wherein the basic material is at least one of sodium hydroxide, calcium hydroxide, sodium carbonate, or sodium bicarbonate.

In some embodiments, the techniques described herein relate to a process, wherein the clean water stream includes less than 0.05% of organic acid.

In some embodiments, the techniques described herein relate to a process, wherein feeding the membrane feed stream to the membrane system includes feeding the membrane feed stream through the membrane system in a first direction and feeding a water stream through the membrane system in a second direction opposite the first direction.

In some embodiments, the techniques described herein relate to a process, further including heating the evaporator condensate to a temperature within a range of 70º F to 250º F.

In some embodiments, the techniques described herein relate to a process for purifying evaporator condensate including water and organic acids, the process including: separating, via a first reverse osmosis system, at least a first portion of the organic acids from the evaporator condensate to form a first reverse osmosis permeate stream and a first reverse osmosis retentate stream including the at least the first portion of the organic acids; and separating, via a second reverse osmosis system, at least a second portion of the organic acids from the first reverse osmosis permeate stream to form a clean water stream and a second reverse osmosis retentate stream including the at least the second portion of the organic acids.

In some embodiments, the techniques described herein relate to a process, wherein the evaporator condensate further includes oils, and the process further includes: prior to separating the at least the first portion of the organic acids from the evaporator condensate, separating, via a membrane system, at least a third portion of the oils from the evaporator condensate to form a membrane retentate stream including the at least the third portion of the oils.

In some embodiments, the techniques described herein relate to a process, wherein the evaporator condensate further includes solids, and the process further includes: prior to separating the at least the first portion of the organic acids from the evaporator condensate, separating, via a pre-strainer, at least a third portion of the solids from the evaporator condensate to form a pre-strainer reject stream including the at least the third portion of the solids.

In some embodiments, the techniques described herein relate to a process, further including adjusting a pH of the first reverse osmosis permeate stream by mixing one or more materials with the first reverse osmosis permeate stream.

In some embodiments, the techniques described herein relate to a process, wherein the pH of the first reverse osmosis permeate stream is adjusted to a value within a range of 6 to 8.

In some embodiments, the techniques described herein relate to a process, wherein adjusting the pH of the first reverse osmosis permeate stream includes forming one or more salts from the organic acids and the one or more materials.

In some embodiments, the techniques described herein relate to a process, wherein a first temperature of the first reverse osmosis system and a second temperature of the second reverse osmosis system are each within a range of 70º F to 250º F.

In some embodiments, the techniques described herein relate to a system for purifying evaporator condensate including water and organic acids, the system including: a first reverse osmosis system configured to remove at least a first portion of the organic acids from the evaporator condensate to form a first reverse osmosis permeate stream and a first reverse osmosis retentate stream including the at least the first portion of the organic acids; and a second reverse osmosis system configured to remove at least a second portion of the organic acids from the first reverse osmosis permeate stream to form a clean water stream and a second reverse osmosis retentate stream including the at least the second portion of the organic acids.

In some embodiments, the techniques described herein relate to a system, wherein the evaporator condensate further includes solids, and the system further includes a pre-strainer configured to remove at least a third portion of the solids from the evaporator condensate.

In some embodiments, the techniques described herein relate to a system, wherein the evaporator condensate further includes oils, and the system further includes a membrane system configured to remove at least a third portion of the oils from the evaporator condensate.

In some embodiments, the techniques described herein relate to a system, further including: a water stream flowing through the membrane system in a first direction, wherein the evaporator condensate flows through the membrane system in a second direction.

In some embodiments, the techniques described herein relate to a system, further including: one or more materials configured to adjust a pH of the first reverse osmosis permeate stream to a value within a range of 6 to 8; and a tank for mixing the first reverse osmosis permeate stream and the one or more materials.

In some embodiments, the techniques described herein relate to a system, wherein the one or more materials include at least one of sodium hydroxide, calcium hydroxide, sodium carbonate, or sodium bicarbonate.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWINGS

Embodiments of the present disclosure are described in detail below with reference to the attached drawing figures, wherein:

FIG. 1 depicts a schematic view of an exemplary process for purifying an evaporator condensate relating to some embodiments; and

FIG. 2 depicts an exemplary method for purifying an evaporator condensate relating to some embodiments.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description of embodiments of the present disclosure references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. Therefore, the following detailed description is not to be taken in a limiting sense. The scope of embodiments of the present disclosure is defined only by the appended claims, along with the full scope of equivalents to which such claims are entitled.

In this description, references to "one embodiment," "an embodiment," or "embodiments" mean that the feature or features being referred to are included in at least one embodiment of the technology. Separate reference to "one embodiment," "an embodiment," or "embodiments" in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

It should be understood that any numerical range recited herein may be inclusive to the bounds of the range and include all sub-ranges subsumed therein. For example, a range of “50% to 75%” may include any and all sub-ranges between and including the recited minimum value of 50% and the recited maximum value of 75%, that is, all sub-ranges beginning with a minimum value equal to or greater than 50% and ending with a maximum value equal to or less than 75%, and all sub-ranges in between, e.g., 50% to 62%, 65% to 70%, or 67% to 75%. Further, the percentages described herein may refer to a weight basis, a volumetric basis, or a molar basis. For example, an evaporator condensate comprising 50% of a first material may be used to describe an evaporator condensate comprising 50% of a first material based on weight, based on volume, or based on moles. As used herein, “chemical oxygen demand” may refer to the amount of oxygen that can be consumed by reactions (e.g., oxidation reactions) in a measured solution. For example, a solution having a chemical oxygen demand (COD) of 4,000 milligrams per liter (mg/L) may indicate that the solution would require 4,000 mg of oxygen to fully oxidize a liter of the solution. Chemical oxygen demand is commonly used to measure the amount of organic material in a solution because nearly all organic compounds can be fully oxidized.

As described above, previous ethanol distillation processes include evaporating water and oils from the whole stillage to produce syrup and oil products. However, the water evaporated from the whole stillage may comprise contaminants, such as organic acids, oils, alcohols, and/or solids, that prevents the evaporated water from being used in ethanol distillation systems that require clean water (e.g., carbon dioxide scrubbers and/or cooling towers). Feeding water having contaminants (e.g., organic contaminants) to the ethanol distillation systems may cause scum and other contaminants to buildup in the systems, thus requiring frequent shutdown and cleaning of the ethanol distillation systems.

The present disclosure provides techniques for purifying the evaporator condensate to reduce the number of contaminants in the evaporator condensate. Reducing the number of contaminants in the evaporator condensate allows for the resulting clean water stream to be recycled and utilized in the ethanol distillation systems that require clean water (e.g., carbon dioxide scrubbers and/or cooling towers). Accordingly, the present disclosure provides systems and methods for purifying evaporator condensate from an ethanol distillation process that reduces the amount of freshwater required by the ethanol distillation process and the cost associated with the freshwater input of the ethanol distillation process.

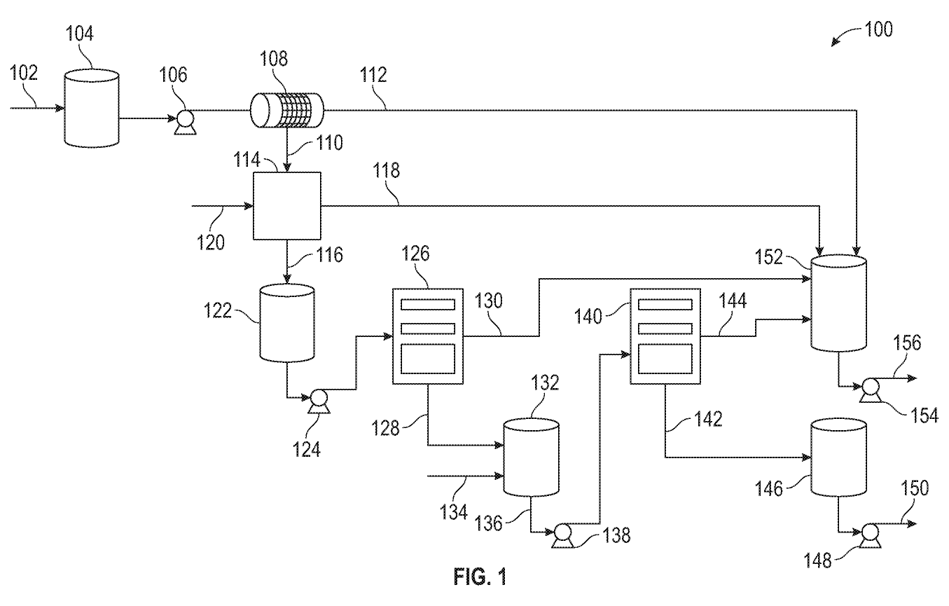

FIG. 1 depicts a schematic view of an exemplary evaporator condensate purification system 100 for purifying a condensate feed stream 102 from one or more evaporators, such as those used in an ethanol distillation process. Evaporator condensate purification system 100 may include one or more separators, filters, strainers, and/or membranes configured to remove contaminants, such as organic acids, oils, alcohols, and/or solids, from condensate feed stream 102 to produce a clean water stream 150 and an evaporator condensate recycle stream 156 containing the removed contaminants. Clean water stream 150 may have a lower contaminant concentration and a lower chemical oxygen demand (COD) than condensate feed stream 102. In operation, evaporator condensate purification system 100 may direct condensate feed stream 102 to a pre-strainer 108 to remove a portion of the contaminants. The partially purified stream may then be processed through a membrane system and/or a reverse osmosis system, to further remove contaminants and produce clean water stream 150.

In some embodiments, condensate feed stream 102 may comprise any combination of water, organic acids, oils, alcohols, or solids, as well as other materials from ethanol distillation processes. For example, condensate feed stream 102 may comprise water and organic acids from an ethanol distillation process.

In some embodiments, the condensate feed stream 102 is received from one or more evaporators (not shown). The condensate feed stream 102 may comprise at least 5%, at least 4%, at least 3%, at least 2.5%, at least 2.25%, at least 2%, at least 1.75%, at least 1.5%, at least 1.25%, or at least 1% of contaminants (e.g., organic acids, oils, alcohols, and/or solids). For example, condensate feed stream 102 may comprise 1.6% of organic acids. In some embodiments, condensate feed stream 102 may have a COD of 1,000 mg/L or greater, 1,250 mg/L or greater, 1,500 mg/L or greater, 1,750 mg/L or greater, 2,000 mg/L or greater, 2,250 mg/L or greater, 2,500 mg/L or greater, 2,750 mg/L or greater, 3,000 mg/L or greater, 3,250 mg/L or greater, 3,500 mg/L or greater, 3,750 mg/L or greater, 4,000 mg/L or greater, 4,250 mg/L or greater, 4,500 mg/L or greater, 4,750 mg/L or greater, 5,000 mg/L or greater, 5,250 mg/L or greater, 5,500 mg/L or greater, 5,750 mg/L or greater, or 6,000 mg/L or greater.

In some embodiments, condensate feed stream 102 may be fed to a holding tank 104. Holding tank 104 may control at least one of the temperature, pressure, and/or flow rate of condensate feed stream 102. Holding tank 104 may control the temperature of condensate feed stream 102 within a range of 70º F to 250º F, 70º F to 200º F, 100º F to 200º F, or 150º F to 200º F. Holding tank 104 may control the pressure of condensate feed stream 102 of up to 20 pounds per square inch (psi), within a range of 20 psi to 75 psi, within a range of 30 psi to 60 psi, or within a range of 40 psi to 50 psi. Holding tank 104 may control the flow rate of condensate feed stream 102 up to 100 gallons per minute (gpm), up to 200 gpm, up to 300 gpm, up to 400 gpm, up to 500 gpm, up to 600 gpm, up to 700 gpm, up to 800 gpm, up to 900 gpm, or up to 1,000 gpm. In some embodiments, evaporator condensate purification system 100 may hold one or more process streams under the conditions described above. For example, the material flowing through evaporator condensate purification system 100 may maintain at least one of the temperature, the pressure, and/or the flow rate ranges described above. Embodiments are contemplated in which evaporator condensate purification system 100 may operate at a temperature, pressure, and/or flow rate outside of the ranges described above.

In some embodiments, the tanks described herein (e.g., holding tank 104, holding tank 122, holding tank 132, holding tank 146, and/or holding tank 152) may comprise one or more heating elements to control the temperature of the material within the tank and one or more valves to control the flow rate of the material leaving the tank. Further, the tanks described herein may be pressurized to control the pressure of the material leaving the tank. Alternatively, or additionally, the tanks described herein may feed material to a pump to pressurize the material leaving the tank. In some embodiments, holding tank 104 may comprise one or more mixers to homogenize condensate feed stream 102. For example, condensate feed stream 102 may comprise water and one or more contaminants, and holding tank 104 may comprise at least one mixer to homogenize the water and one or more contaminants within condensate feed stream 102. Embodiments are contemplated in which other techniques for controlling the temperature, the pressure, and/or the flow rate may be utilized to control the conditions of condensate feed stream 102. For example, any combination of pumps, heating elements, or control valves, as well as other active or passive control means may be utilized to control the conditions of condensate feed stream 102.

In some embodiments, pump 106 may be utilized to pressurize condensate feed stream 102. For example, pump 106 may pressurize condensate feed stream 102 exiting holding tank 104. Pump 106 may pressurize condensate feed stream 102 such that condensate feed stream 102 flows through one or more process units downstream from pump 106, such as pre-strainer 108 and/or membrane system 114 (described further below). In some embodiments, pump 106 may pressurize condensate feed stream 102 to a pressure of up to 20 psi, within a range of 20 psi to 75 psi, within a range of 30 psi to 60 psi, or within a range of 40 psi to 50 psi. The pumps described herein (e.g., pump 106, pump 124, pump 138, pump 148, and/or pump 154) may be utilized to maintain pressure throughout evaporator condensate purification system 100. For example, each pump described herein may pressurize a process stream to maintain a range of pressure, such as the ranges of pressure described above.

In some embodiments, evaporator condensate purification system 100 may comprise a pre-strainer 108 configured to remove at least a portion of the contaminants (e.g., organic acids, oils, alcohols, and/or solids) from condensate feed stream 102. For example, pre-strainer 108 may be configured to remove at least a portion of the solids from condensate feed stream 102. In some embodiments, pre-strainer 108 may separate condensate feed stream 102 into a membrane feed stream 110 and a pre-strainer reject stream 112 comprising the separated contaminants (e.g., solids). Accordingly, membrane feed stream 110 may comprise a lower percentage of contaminants compared to condensate feed stream 102. Embodiments are contemplated in which pre-strainer 108 may be optional. For example, pre-strainer 108 may be omitted from evaporator condensate purification system 100 such that condensate feed stream 102 flows to membrane system 114 (described further below) without flowing through pre-strainer 108.

In some embodiments, evaporator condensate purification system 100 may further comprise a membrane system 114. In some embodiments, a “membrane” or a “membrane system” may refer to a selective barrier configured to allow specific materials to pass through the membrane while preventing other materials from passing through the membrane. For example, a membrane system may refer to a filtration screen that allows liquids, such as water, to pass through the filtration screen and prevents solids from passing through the filtration screen. In another example, a membrane system may refer to a filtration screen that allows liquids of a predetermined size or smaller to pass through the filtration screen and prevents liquids having a size larger than the predetermined size from passing through the filtration screen.

In some embodiments, membrane feed stream 110 may be fed to membrane system 114 where one or more contaminants (e.g., organic acids, oils, alcohols, and/or solids) are removed from membrane feed stream 110. For example, membrane system 114 may be configured to remove at least a portion of the oils and/or solids from membrane feed stream 110. In some embodiments, membrane system 114 may separate membrane feed stream 110 into a membrane permeate stream 116 and a membrane retentate stream 118 comprising the separated contaminants (e.g., oils, alcohols, and/or solids). Accordingly, membrane permeate stream 116 may comprise a lower percentage of contaminants compared to membrane feed stream 110 and/or condensate feed stream 102.

In some embodiments, a water stream 120 may optionally be fed to membrane system 114 to facilitate the removal of one or more contaminants. In some embodiments, water stream 120 may flow through membrane system 114 in a first direction and membrane feed stream 110 may flow through membrane system 114 in a second direction such that membrane feed stream 110 contacts water stream 120 and separates into membrane permeate stream 116 and membrane retentate stream 118. The membrane permeate stream 116 may comprise the portion of membrane feed stream 110 that passes through the membrane, while the membrane retentate stream 118 may comprise the portion of membrane feed stream 110 that is retained by the membrane. In some embodiments, membrane feed stream 110 and water stream 120 may flow through membrane system 114 using cocurrent flow, countercurrent flow, and/or crossflow. For example, water stream 120 may flow through membrane system 114 in a first direction and membrane feed stream 110 may flow through membrane system 114 in a second direction opposite the first direction. Embodiments are contemplated in which membrane system 114 may be optional. For example, membrane system 114 may be omitted from evaporator condensate purification system 100 such that condensate feed stream 102 or membrane feed stream 110 may be fed to first reverse osmosis system 126 (described further below) without flowing through membrane system 114.

In some embodiments, membrane permeate stream 116 may then be fed to a holding tank 122. Holding tank 122 may control at least one of a temperature, a pressure, or a flow rate of membrane permeate stream 116. Holding tank 122 may control the temperature of condensate feed stream 102 within a range of 70º F to 250º F., 70º F. to 200º F., 100º F. to 200º F., or 150º F. to 200º F. Holding tank 122 may control the pressure of condensate feed stream 102 of up to 20 psi, within a range of 20 psi to 75 psi, within a range of 30 psi to 60 psi, or within a range of 40 psi to 50 psi. Holding tank 122 may control the flow rate of condensate feed stream 102 up to 100 gpm, up to 200 gpm, up to 300 gpm, up to 400 gpm, up to 500 gpm, up to 600 gpm, up to 700 gpm, up to 800 gpm, up to 900 gpm, or up to 1,000 gpm.

In some embodiments, a pump 124 may be utilized to pressurize membrane permeate stream 116. For example, pump 124 may pressurize membrane permeate stream 116 exiting holding tank 122. In some embodiments, pump 124 may pressurize membrane permeate stream 116 such that membrane permeate stream 116 flows through one or more downstream process units. In some embodiments, pump 124 may pressurize membrane permeate stream 116 to a pressure of up to 20 psi, within a range of 20 psi to 75 psi, within a range of 30 psi to 60 psi, or within a range of 40 psi to 50 psi.

In some embodiments, evaporator condensate purification system 100 may further comprise a first reverse osmosis system 126 to remove at least a portion of the contaminants (e.g., organic acids, oils, alcohols, and/or solids) from membrane permeate stream 116. For example, first reverse osmosis system 126 may be configured to remove at least a portion of the organic acids from membrane permeate stream 116. In some embodiments, first reverse osmosis system 126 may separate membrane permeate stream 116 into a first reverse osmosis permeate stream 128 and a first reverse osmosis retentate stream 130 comprising the separated contaminants (e.g., organic acids and/or alcohols).

In some embodiments, first reverse osmosis system 126 may be configured to remove at least 75%, at least 80%, at least 85%, or at least 90% of the contaminants (e.g., organic acids, oils, alcohols, and/or solids) from membrane permeate stream 116 to form first reverse osmosis permeate stream 128. For example, first reverse osmosis system 126 may be configured to remove at least 90% of organic acids from membrane permeate stream 116 to form first reverse osmosis permeate stream 128. In some embodiments, first reverse osmosis system 126 may reduce the COD of membrane permeate stream 116 such that first reverse osmosis permeate stream 128 has a lower COD value than membrane permeate stream 116. For example, first reverse osmosis permeate stream 128 may have a COD of 750 mg/L or less, 700 mg/L or less, 650 mg/L or less, 600 mg/L or less, 550 mg/L or less, 500 mg/L or less, 450 mg/L or less, 400 mg/L or less, 350 mg/L or less, 300 mg/L or less, 250 mg/L or less, 200 mg/L or less, 150 mg/L or less, or 100 mg/L or less.

In some embodiments, evaporator condensate purification system 100 may further comprise a holding tank 132. In some embodiments, first reverse osmosis permeate stream 128 may be fed to holding tank 132. Further, one or more materials 134 may be added to holding tank 132 to adjust the pH of first reverse osmosis permeate stream 128 to form a pH adjusted stream 136. In some embodiments, one or more materials 134 may comprise an acidic material (i.e., a material having a pH less than 7) or a basic material (i.e., a material having a pH greater than 7). For example, one or more materials 134 may comprise a basic material to adjust the pH of a first reverse osmosis permeate stream 128 having a pH less than 7. In another example, one or more materials 134 may comprise an acidic material to adjust the pH of a first reverse osmosis permeate stream 128 having a pH greater than 7.

In some embodiments, first reverse osmosis permeate stream 128 may have a pH of 6.5 or lower, 6 or lower, 5.5 or lower, 5 or lower, 4.5 or lower, 4 or lower, or 3.5 or lower. For example, first reverse osmosis permeate stream 128 may have a pH of 3.8. In some embodiments, one or more materials 134 may comprise one or more basic materials to adjust the pH of an acidic first reverse osmosis permeate stream 128. For example, one or more materials 134 may comprise at least one of sodium hydroxide, calcium hydroxide, sodium carbonate, or sodium bicarbonate. In some embodiments, first reverse osmosis permeate stream 128 may have a pH of greater than 7.5, greater than 8, greater than 8.5, greater than 9, greater than 9.5, greater than 10, or greater than 10.5. In some embodiments, one or more materials 134 may comprise one or more acidic materials to adjust the pH of a basic first reverse osmosis permeate stream 128. For example, one or more materials 134 may comprise at least one of hydrochloric acid, sulfuric acid, or phosphoric acid.

In some embodiments, one or more materials 134 may adjust the pH of first reverse osmosis permeate stream 128 within a range of 6 to 8, within a range of 6.5 to 7.5, within a range of 6.75 to 7.25, or within a range of 6.9 to 7.1. For example, one or more material 134 may adjust the pH of first reverse osmosis permeate stream 128 from 4 to 7. Accordingly, pH adjusted stream 136 may have a pH within a range of 6 to 8, within a range of 6.5 to 7.5, within a range of 6.75 to 7.25, or within a range of 6.9 to 7.1. In some embodiments, adding one or more materials 134 may cause one or more salts to form. For example, adding sodium hydroxide to first reverse osmosis permeate stream 128 comprising organic acids may form one or more salts from the sodium hydroxide and the organic acid. In some embodiments, forming one or more salts by adjusting the pH of first reverse osmosis permeate stream 128 with one or more materials 134 may facilitate the separation of contaminants from pH adjusted stream 136 (e.g., separation of contaminants from pH adjusted stream 136 via second reverse osmosis system 140 described below).

Embodiments are contemplated in which one or more materials 134 may be added at one or more locations within evaporator condensate purification system 100. For example, one or more materials 134 may be added to at least one of holding tank 104, holding tank 122, or holding tank 132. Embodiments are contemplated in which one or more materials 134 may be omitted from evaporator condensate purification system 100. For example, one or more materials 134 may not be fed to holding tank 132 such that the pH of first reverse osmosis permeate stream 128 is not adjusted and first reverse osmosis permeate stream 128 is fed to second reverse osmosis system 140 (described further below).

In some embodiments, holding tank 132 may control at least one of the temperature, pressure, and/or flow rate of pH adjusted stream 136. Holding tank 132 may control the temperature of condensate feed stream 102 within a range of 70º F. to 250º F., 70º F. to 200º F., 100º F. to 200º F., or 150º F. to 200º F. Holding tank 132 may control the pressure of condensate feed stream 102 of up to 20 psi, within a range of 20 psi to 75 psi, within a range of 30 psi to 60 psi, or within a range of 40 psi to 50 psi. Holding tank 132 may control the flow rate of condensate feed stream 102 up to 100 gpm, up to 200 gpm, up to 300 gpm, up to 400 gpm, up to 500 gpm, up to 600 gpm, up to 700 gpm, up to 800 gpm, up to 900 gpm, or up to 1,000 gpm.

In some embodiments, a pump 138 is utilized to pressurize pH adjusted stream 136. For example, pump 138 may pressurize pH adjusted stream 136 exiting holding tank 132. Pump 138 may pressurize pH adjusted stream 136 to flow pH adjusted stream 136 through one or more downstream process units. In some embodiments, pump 138 may pressurize pH adjusted stream 136 to a pressure of up to 20 psi, within a range of 20 psi to 75 psi, within a range of 30 psi to 60 psi, or within a range of 40 psi to 50 psi.

In some embodiments, evaporator condensate purification system 100 may further comprise a second reverse osmosis system 140 configured to remove at least a portion of the contaminants (e.g., salts, organic acids, oils, alcohols, and/or solids) from pH adjusted stream 136. For example, second reverse osmosis system 140 may be configured to remove at least a portion of the one or more salts, organic acids and/or alcohols from pH adjusted stream 136. In some embodiments, second reverse osmosis system 140 may separate pH adjusted stream 136 into a second reverse osmosis permeate stream 142 and a second reverse osmosis retentate stream 144. In some embodiments, adjusting the pH of the process stream prior to entering second reverse osmosis system 140 may facilitate the removal of one or more contaminants. For example, adding a basic material to a process stream comprising organic acids may form salts that are more easily separated from water than the organic acids from water.

In some embodiments, second reverse osmosis system 140 may be configured to remove at least 85%, at least 87.5%, at least 90%, at least 92.5%, at least 95%, at least 97.5%, or at least 99% of the contaminants (e.g., organic acids, oils, alcohols, and/or solids) from pH adjusted stream 136 to form second reverse osmosis permeate stream 142. For example, second reverse osmosis system 140 may remove at least 95% of the contaminates from pH adjusted stream 136 to form second reverse osmosis permeate stream142. In some embodiments, second reverse osmosis system 140 may reduce the COD of pH adjusted stream 136 such that second reverse osmosis permeate stream 142 has a lower COD value than pH adjusted stream 136. For example, second reverse osmosis permeate stream 142 may have a COD of 100 mg/L or less, 90 mg/L or less, 80 mg/L or less, 70 mg/L or less, 60 mg/L or less, 50 mg/L or less, 40 mg/L or less, 30 mg/L or less, or 25 mg/L or less.

In some embodiments, second reverse osmosis permeate stream 142 may be sent to a holding tank 146. Holding tank 146 may control at least one of a temperature, a pressure, or a flow rate of second reverse osmosis permeate stream 142. Holding tank 146 may control the temperature of second reverse osmosis permeate stream 142 within a range of 70º F. to 250º F., 70º F. to 200º F., 100º F. to 200º F., or 150º F. to 200º F. Holding tank 146 may control the pressure of second reverse osmosis permeate stream 142 of up to 20 psi, within a range of 20 psi to 75 psi, within a range of 30 psi to 60 psi, or within a range of 40 psi to 50 psi. Holding tank 146 may control the flow rate of second reverse osmosis permeate stream 142 up to 100 gpm, up to 200 gpm, up to 300 gpm, up to 400 gpm, up to 500 gpm, up to 600 gpm, up to 700 gpm, up to 800 gpm, up to 900 gpm, or up to 1,000 gpm.

In some embodiments, a pump 148 may be utilized to pressurize second reverse osmosis permeate stream 142. For example, pump 148 may pressurize second reverse osmosis permeate stream 142 exiting holding tank 146. Pump 148 may pressurize second reverse osmosis permeate stream 142 to flow second reverse osmosis permeate stream 142 through one or more downstream process units. In some embodiments, pump 148 may pressurize second reverse osmosis permeate stream 142 to a pressure of up to 20 psi, within a range of 20 psi to 75 psi, within a range of 30 psi to 60 psi, or within a range of 40 psi to 50 psi.

In some embodiments, second reverse osmosis permeate stream 142 may be a clean water stream 150. In some embodiments, clean water stream 150 may comprise less than 1%, less than 0.75%, less than 0.5%, less than 0.25%, less than 0.1%, less than 0.075%, less than 0.05%, less than 0.025%, or less than 0.01% of contaminants (e.g., salts, organic acids, oils, alcohols, and/or solids). For example, clean water stream 150 may comprise 0.027% of organic acids. In some embodiments, clean water stream 150 may have a COD of 100 mg/L or less, 90 mg/L or less, 80 mg/L or less, 70 mg/L or less, 60 mg/L or less, 50 mg/L or less, 40 mg/L or less, 30 mg/L or less, or 25 mg/L or less. In some embodiments, clean water stream 150 may comprise at least 15%, at least 20%, at least 25%, at least 30%, at least 33%, at least 35%, or at least 40% of the water from condensate feed stream 102. Embodiments are contemplated in which second reverse osmosis permeate stream 142 may undergo one or more separations before being output as clean water stream 150. For example, second reverse osmosis permeate stream 142 may be fed to an additional reverse osmosis system configured to further purify second reverse osmosis permeate stream 142 to form clean water stream 150. As described above, clean water stream 150 may be recycled to at least one of a cooling tower or a carbon dioxide scrubber of an ethanol distillation process. Embodiments are contemplated in which clean water stream 150 may be recycled to any suitable system that utilize clean water.

In some embodiments, evaporator condensate purification system 100 may further comprise a holding tank 152 configured to hold one or more reject and/or retentate streams. In some embodiments, any combination of pre-strainer reject stream 112, membrane retentate stream 118, first reverse osmosis retentate stream 130, or second reverse osmosis retentate stream 144 may be fed to holding tank 152. Accordingly, holding tank 152 may be configured to mix one or more reject and/or retentate streams to form evaporator condensate recycle stream 156. Evaporator condensate recycle stream 156 may comprise the one or more contaminants (e.g., salts, organic acids, oils, alcohols, and/or solids) removed via at least one of pre-strainer 108, membrane system 114, first reverse osmosis system 126, or second reverse osmosis system 140. Further, evaporator condensate recycle stream 156 may comprise up to 85%, up to 80%, up to 70%, up to 67%, up to 65%, or up to 60% of the water from condensate feed stream 102. In some embodiments, evaporator condensate recycle stream 156 may be recycled to one or more systems of an ethanol distillation process that requires water. For example, evaporator condensate recycle stream 156 may be recycled to a tank for mixing grains and water to form a slurry for fermenting in an ethanol distillation process.

In some embodiments, holding tank 152 may control at least one of the temperature, pressure, and/or flow rate of evaporator condensate recycle stream 156. Holding tank 152 may control the temperature of evaporator condensate recycle stream 156 within a range of 70º F. to 250º F., 70º F. to 200º F., 100º F. to 200º F., or 150º F. to 200º F. Holding tank 152 may control the pressure of evaporator condensate recycle stream 156 of up to 20 psi, within a range of 20 psi to 75 psi, within a range of 30 psi to 60 psi, or within a range of 40 psi to 50 psi. Holding tank 152 may control the flow rate of evaporator condensate recycle stream 156 up to 100 gpm, up to 200 gpm, up to 300 gpm, up to 400 gpm, up to 500 gpm, up to 600 gpm, up to 700 gpm, up to 800 gpm, up to 900 gpm, or up to 1,000 gpm.

In some embodiments, a pump 154 may be utilized to pressurize evaporator condensate recycle stream 156. For example, pump 154 may pressurize evaporator condensate recycle stream 156 exiting holding tank 152. Pump 154 may pressurize evaporator condensate recycle stream 156 to flow evaporator condensate recycle stream 156 to one or more downstream processes (e.g., a tank of an ethanol distillation process for producing a feedstock slurry). In some embodiments, pump 154 may pressurize evaporator condensate recycle stream 156 to a pressure of up to 20 psi, within a range of 20 psi to 75 psi, within a range of 30 psi to 60 psi, or within a range of 40 psi to 50 psi.

The order of the one or more separators in evaporator condensate purification system 100 may be configured to prevent one or more contaminants from reaching later separators. For example, pre-strainer 108 may prevent at least a portion of the solids in condensate feed stream 102 from reaching membrane system 114, first reverse osmosis system 126, and second reverse osmosis system 140. In another example, membrane system 114 may prevent at least a portion of the oils in condensate feed stream 102 from reaching first reverse osmosis system 126 and second reverse osmosis system 140. In some embodiments, preventing one or more contaminants from reaching later separators may increase the effectiveness and/or longevity of the separators. For example, preventing oils and/or solids from reaching later separators may prevent the later separators from becoming saturated with the oils and/or solids such that the later separators more effectively remove other contaminants (e.g., organic acids and/or alcohols).

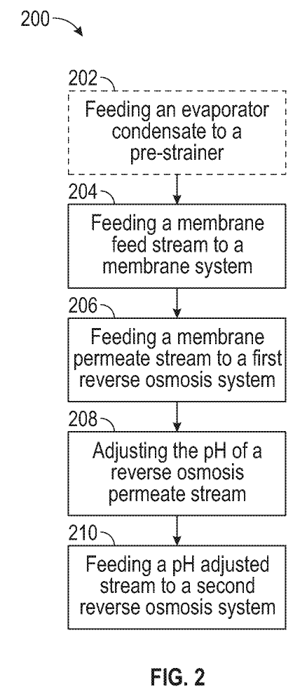

FIG. 2 depicts an exemplary method 200 for purifying an evaporate condensate, such as an evaporator condensate from one or more evaporators in an ethanol distillation process. At step 202, the evaporator condensate may be fed to a pre-strainer, such as pre-strainer 108 described above. The pre-strainer may remove one or more contaminants (e.g., organic acids, oils, alcohols, and/or solids) from the evaporator condensate (e.g., condensate feed stream 102) to form a membrane feed stream (e.g., membrane feed stream 110) and a pre-strainer reject stream (e.g., pre-strainer reject stream 112) comprising the separated contaminants. For example, the pre-strainer may remove at least a portion of the solids from the evaporator condensate to form a membrane feed stream and a pre-strainer reject stream comprising the at least a portion of the solids. In some embodiments, step 202 may be optional. For example, step 202 may be omitted from method 200 such that evaporator condensate is fed to the membrane system described below.

At step 204, the membrane feed stream from the pre-strainer may be fed to a membrane system, such as membrane system 114 described above. The membrane system may remove one or more contaminants (e.g., organic acids, oils, alcohols, and/or solids) from the membrane feed stream (e.g., membrane feed stream 110) to form a membrane permeate stream (e.g., membrane permeate stream 116) and a membrane retentate stream (e.g., membrane retentate stream 118) comprising the separated contaminants. For example, the membrane system may remove at least a portion of the oils from the membrane feed stream to form a membrane permeate stream and a membrane retentate stream comprising the at least a portion of the oils.

In some embodiments, step 204 may include feeding a water stream (e.g., water stream 120) through the membrane system in a first direction and feeding the membrane feed stream through the membrane system in a second direction such that the membrane feed stream contacts the water stream and separates into the membrane permeate stream and the membrane retentate stream. In some embodiments, the membrane feed stream and the water stream may flow through the membrane system using cocurrent flow, countercurrent flow, and/or crossflow. For example, the water stream may flow through the membrane system in a first direction and the membrane feed stream may flow through the membrane system in a second direction opposite the first direction. Embodiments are contemplated in which step 204 may be optional. For example, step 204 may be omitted from method 200 such that the evaporator condensate and/or the membrane feed stream may be fed to the first reverse osmosis system described below.

At step 206, the evaporator condensate is then fed to a first reverse osmosis system, such as first reverse osmosis system 126 described above. First reverse osmosis system may remove one or more contaminants (e.g., organic acids, oils, alcohols, and/or solids) from the membrane permeate stream (e.g., membrane permeate stream 116) to form a first reverse osmosis permeate stream (e.g., first reverse osmosis permeate stream 128) and a first reverse osmosis retentate stream (e.g., first reverse osmosis retentate stream 130) comprising the separated contaminants. For example, the first reverse osmosis system may remove at least a portion of the organic acids from the membrane permeate stream to form the first reverse osmosis permeate stream and the first reverse osmosis retentate stream comprising the at least a portion of the organic acids.

In some embodiments, step 206 may remove at least 75%, at least 80%, at least 85%, or at least 90% of the contaminants (e.g., organic acids, oils, alcohols, and/or solids) from the membrane permeate stream to form the first reverse osmosis permeate stream 128. For example, the first reverse osmosis system may remove at least 90% of organic acids from the membrane permeate stream to form the first reverse osmosis permeate stream. In some embodiments, step 206 may reduce the COD of the membrane permeate stream such that the first reverse osmosis permeate stream has a lower COD value than the membrane permeate stream. For example, the first reverse osmosis permeate stream may have a COD of 750 mg/L or less, 700 mg/L or less, 650 mg/L or less, 600 mg/L or less, 550 mg/L or less, 500 mg/L or less, 450 mg/L or less, 400 mg/L or less, 350 mg/L or less, 300 mg/L or less, 250 mg/L or less, 200 mg/L or less, 150 mg/L or less, or 100 mg/L or less.

At step 208, one or more materials (e.g., one or more materials 134) may be added to the first reverse osmosis permeate stream (e.g., first reverse osmosis permeate stream 128) to adjust the pH of the first reverse osmosis permeate stream and form a pH adjusted stream (e.g., pH adjusted stream 136). In some embodiments, step 208 may include mixing the one or more materials and the first reverse osmosis permeate stream in a tank, such as holding tank 132 described above. At step 208, the pH of the first reverse osmosis permeate stream may be adjusted to a value between a range of 6 to 8, within a range of 6.5 to 7.5, within a range of 6.75 to 7.25, or within a range of 6.9 to 7.1 to form the pH adjusted stream. For example, the pH of the first reverse osmosis permeate stream may be adjusted to a value of 7 such that the pH adjusted stream has a pH of 7.

In some embodiments, the first reverse osmosis permeate stream may have a pH of 6.5 or lower, 6 or lower, 5.5 or lower, 5 or lower, 4.5 or lower, 4 or lower, or 3.5 or lower. For example, the first reverse osmosis permeate stream may comprise one or more organic acids and have a pH of 3.8. In some embodiments, the one or more materials may comprise one or more basic materials to adjust the pH of an acidic first reverse osmosis permeate stream (i.e., a first reverse osmosis permeate stream having a pH lower than 7). For example, the one or more materials may comprise at least one of sodium hydroxide, calcium hydroxide, sodium carbonate, or sodium bicarbonate. In some embodiments, the first reverse osmosis permeate stream may have a pH of greater than 7.5, greater than 8, greater than 8.5, greater than 9, greater than 9.5, greater than 10, or greater than 10.5. In some embodiments, the one or more materials may comprise one or more acidic materials to adjust the pH of a basic first reverse osmosis permeate stream (i.e., a first reverse osmosis permeate stream having a pH greater than 7). For example, the one or more materials may comprise at least one of hydrochloric acid, sulfuric acid, or phosphoric acid.

In some embodiments, step 208 may include causing one or more salts to form. For example, adding one or more materials (e.g., one or more basic materials) to the first reverse osmosis permeate stream comprising one or more contaminants (e.g., organic acids) may form one or more salts from the one or more materials and the one or more contaminants. In some embodiments, adjusting the pH of the reverse osmosis permeate stream may facilitate separation of one or more contaminants (e.g., organic acids, oils, alcohols, and/or solids) from the pH adjusted stream (described further below). For example, forming one or more salts by adjusting the pH of the first reverse osmosis permeate stream with one or more materials may facilitate the separation of organic acids from the pH adjusted stream (e.g., described further below).

Embodiments are contemplated in which step 208 may be performed one or more times within method 200. For example, step 208 may be performed one or more times such that one or more materials may be added to at least one an evaporator condensate, a membrane feed stream, a membrane permeate stream, a first reverse osmosis permeate stream, a pH adjusted stream, or a second reverse osmosis permeate stream. Embodiments are contemplated in which step 208 is optional. For example, step 208 may be omitted from method 200 such that the first reverse osmosis permeate stream is fed to the second reverse osmosis system described below.

At step 210, the pH adjusted stream is fed to a second reverse osmosis system, such as second reverse osmosis system 140. The second reverse osmosis system may remove one or more contaminants (e.g., organic acids, oils, alcohols, and/or solids) from the pH adjusted stream (e.g., pH adjusted stream 136) to form a second reverse osmosis permeate stream (e.g., second reverse osmosis permeate stream 142) and a second reverse osmosis retentate stream (e.g., second reverse osmosis retentate stream 144) comprising the separated contaminants. For example, the second reverse osmosis system may remove at least a portion of the organic acids from the pH adjusted stream to form the second reverse osmosis permeate stream and the second reverse osmosis retentate stream comprising the at least a portion of the organic acids.

In some embodiments, step 210 may remove at least 85%, at least 87.5%, at least 90%, at least 92.5%, at least 95%, at least 97.5%, or at least 99% of the contaminants (e.g., organic acids, oils, alcohols, and/or solids) from the pH adjusted stream to form the second reverse osmosis permeate stream. For example, the second reverse osmosis system may remove at least 95% of the contaminates from the pH adjusted stream to form the second reverse osmosis permeate stream. In some embodiments, step 210 may reduce the COD of the pH adjusted stream such that the second reverse osmosis permeate stream has a lower COD value than the pH adjusted stream. For example, the second reverse osmosis permeate stream may have a COD of 100 mg/L or less, 90 mg/L or less, 80 mg/L or less, 70 mg/L or less, 60 mg/L or less, 50 mg/L or less, 40 mg/L or less, 30 mg/L or less, or 25 mg/L or less.

In some embodiments, the second reverse osmosis permeate may be a clean water stream, such as clean water stream 150 described above. Accordingly, the second reverse osmosis permeate stream may be recycled to one or more systems of an ethanol distillation process that require clean water. For example, the second reverse osmosis permeate may be recycled to one or more cooling towers and/or one or more carbon dioxide scrubbers of an ethanol distillation process. In some embodiments, at least one of the pre-strainer reject stream, the membrane retentate stream, the first reverse osmosis retentate stream, or the second reverse osmosis retentate stream may be recycled to one or more systems of an ethanol distillation process that require water. For example, at least one of the pre-strainer reject stream, the membrane retentate stream, the first reverse osmosis retentate stream, or the second reverse osmosis retentate stream may be mixed with ground grain to form a grain mash for fermenting in an ethanol distillation process.

In some embodiments, method 200 may further comprise one or more steps for controlling at least one of the temperature, the pressure, and/or the flow rate of one or more process streams (e.g., an evaporator condensate, a membrane feed stream, a membrane permeate stream, a first reverse osmosis permeate stream, a pH adjusted stream, and/or a second reverse osmosis permeate stream). For example, at least one of the temperature, the pressure, and/or the flow rate of one or more process streams may be controlled using at least one of holding tanks, pumps, or heating elements. In some embodiments, the temperature of one or more process streams may be controlled within a range of 70º F. to 250º F., 70º F. to 200º F., 100º F. to 200º F., or 150º F. to 200º F. In some embodiments, the pressure of one or more process streams may be controlled up to 20 psi, within a range of 20 psi to 75 psi, within a range of 30 psi to 60 psi, or within a range of 40 psi to 50 psi. In some embodiments, the flow rate of one or more process streams may be controlled up to 100 gpm, up to 200 gpm, up to 300 gpm, up to 400 gpm, up to 500 gpm, up to 600 gpm, up to 700 gpm, up to 800 gpm, up to 900 gpm, or up to 1,000 gpm.

Features described above as well as those claimed below may be combined in various ways without departing from the scope hereof. The following examples illustrate some possible, non-limiting combinations:
Clause 1. A process for purifying evaporator condensate comprising water, solids, oils, and organic acids, the process comprising: feeding the evaporator condensate to a pre-strainer to remove at least a first portion of the solids to form a membrane feed stream and a pre-strainer reject stream comprising the at least the first portion of the solids; feeding the membrane feed stream to a membrane system to remove at least a second portion of the oils to form a membrane permeate stream and a membrane retentate stream comprising the at least the second portion of the oils; feeding the membrane permeate stream to a first reverse osmosis system to remove at least a third portion of the organic acids from the membrane permeate stream to form a first reverse osmosis permeate stream and a first reverse osmosis retentate stream comprising the at least the third portion of the organic acids; adjusting a pH of the first reverse osmosis retentate stream to form a pH adjusted stream; and feeding the pH adjusted stream to a second reverse osmosis system to remove at least a fourth portion of the organic acids from the pH adjusted stream to form a clean water stream and a second reverse osmosis retentate stream comprising the at least the fourth portion of the organic acids.
Clause 2. The process of clause 1, wherein adjusting the pH of the first reverse osmosis retentate stream includes adding a basic material to the first reverse osmosis retentate stream to form the pH adjusted stream.
Clause 3. The process of any of clauses 1 through 2, wherein the pH of the pH adjusted stream is within a range of 6 to 8.
Clause 4. The process of any of clauses 1 through 3, wherein the basic material is at least one of sodium hydroxide, calcium hydroxide, sodium carbonate, or sodium bicarbonate.
Clause 5. The process of any of clauses 1 through 4, wherein the clean water stream comprises less than 0.05% of organic acid.
Clause 6. The process of any of clauses 1 through 5, wherein feeding the membrane feed stream to the membrane system includes feeding the membrane feed stream through the membrane system in a first direction and feeding a water stream through the membrane system in a second direction
Clause 7. The process of any of clauses 1 through 6, wherein the second direction is opposite the first direction.
Clause 8. The process of any of clauses 1 through 7, further comprising heating the evaporator condensate to a temperature within a range of 70º F to 250º F.
Clause 9. A process for purifying evaporator condensate comprising water and organic acids, the process comprising: separating, via a first reverse osmosis system, at least a first portion of the organic acids from the evaporator condensate to form a first reverse osmosis permeate stream and a first reverse osmosis retentate stream comprising the at least the first portion of the organic acids; and separating, via a second reverse osmosis system, at least a second portion of the organic acids from the first reverse osmosis permeate stream to form a clean water stream and a second reverse osmosis retentate stream comprising the at least the second portion of the organic acids.
Clause 10. The process of clause 9, wherein the evaporator condensate further comprises oils, and the process further comprises: prior to separating the at least the first portion of the organic acids from the evaporator condensate, separating, via a membrane system, at least a third portion of the oils from the evaporator condensate to form a membrane retentate stream comprising the at least the third portion of the oils.
Clause 11. The process of any of clauses 9 through 10, wherein the evaporator condensate further comprises solids, and the process further comprises: prior to separating the at least the first portion of the organic acids from the evaporator condensate, separating, via a pre-strainer, at least a third portion of the solids from the evaporator condensate to form a pre-strainer reject stream comprising the at least the third portion of the solids.
Clause 12. The process of any of clauses 9 through 11, further comprising adjusting a pH of the first reverse osmosis permeate stream by mixing one or more materials with the first reverse osmosis permeate stream.
Clause 13. The process of any of clauses 9 through 12, wherein the pH of the first reverse osmosis permeate stream is adjusted to a value within a range of 6 to 8.
Clause 14. The process of any of clauses 9 through 13, wherein adjusting the pH of the first reverse osmosis permeate stream includes forming one or more salts from the organic acids and the one or more materials.
Clause 15. The process of any of clauses 9 through 14, wherein a first temperature of the first reverse osmosis system and a second temperature of the second reverse osmosis system are each within a range of 70º F to 250º F.
Clause 16. The process of any of clauses 9 through 15, wherein the clean water stream comprises less than 0.5% of the organic acids.
Clause 17. The process of any of clauses 9 through 16, wherein the clean water stream has a COD of 100 mg/L or less.
Clause 18. The process of any of clauses 9 through 17, wherein the clean water stream comprises at least 25% of the water from the evaporator condensate.
Clause 19. The process of any of clauses 9 through 18, further comprising heating the evaporator condensate to a temperature within a range of 70º F. to 250º F.
Clause 20. The process of any of clauses 9 through 19, further comprising pressurizing the evaporator condensate to a pressure within a range of 20 psi to 75 psi.
Clause 21. The process of any of clauses 9 through 20, further comprising controlling the flow rate of the evaporator condensate to a value of up to 1,000 gpm.
Clause 22. The process of any of clauses 9 through 21, wherein the clean water stream comprises less than 1% of organic acids, oils, alcohols, and solids. Clause
23. A system for purifying evaporator condensate comprising water and organic acids, the system comprising: a first reverse osmosis system configured to remove at least a first portion of the organic acids from the evaporator condensate to form a first reverse osmosis permeate stream and a first reverse osmosis retentate stream comprising the at least the first portion of the organic acids; and a second reverse osmosis system configured to remove at least a second portion of the organic acids from the first reverse osmosis permeate stream to form a clean water stream and a second reverse osmosis retentate stream comprising the at least the second portion of the organic acids.
Clause 24. The system of clause 23, wherein the evaporator condensate further comprises solids, and the system further comprises a pre-strainer configured to remove at least a third portion of the solids from the evaporator condensate.
Clause 25. The system of any of clauses 23 through 24, wherein the evaporator condensate further comprises oils, and the system further comprises a membrane system configured to remove at least a third portion of the oils from the evaporator condensate.
Clause 26. The system of any of clauses 23 through 25, further comprising: a water stream flowing through the membrane system in a first direction, wherein the evaporator condensate flows through the membrane system in a second direction.
Clause 27. The system of any of clauses 23 through 26, further comprising one or more materials configured to adjust a pH of the first reverse osmosis permeate stream to a value within a range of 6 to 8
Clause 28. The process of any of clauses 23 through 27, further comprising a tank for mixing the first reverse osmosis permeate stream and the one or more materials.
Clause 29. The system of any of clauses 23 through 28, wherein the one or more materials comprise at least one of sodium hydroxide, calcium hydroxide, sodium carbonate, or sodium bicarbonate.
Clause 30. The system of any of clauses 23 through 29, wherein the one or more materials comprise at least one of hydrochloric acid, sulfuric acid, or phosphoric acid.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A process for purifying evaporator condensate comprising water, solids, oils, and organic acids, the process comprising:
feeding the evaporator condensate to a pre-strainer to remove at least a first portion of the solids to form a membrane feed stream and a pre-strainer reject stream, the pre-strainer reject stream comprising at least the first portion of the solids;
feeding the membrane feed stream to a membrane system to remove at least a second portion of the oils to form a membrane permeate stream and a membrane retentate stream, the membrane retentate stream comprising at least the second portion of the oils;
feeding the membrane permeate stream to a first reverse osmosis system to remove at least a third portion of the organic acids from the membrane permeate stream to form a first reverse osmosis permeate stream and a first reverse osmosis retentate stream, the first reverse osmosis retentate stream comprising the at least the third portion of the organic acids;
adjusting a pH of the first reverse osmosis retentate stream to form a pH adjusted stream; and
feeding the pH adjusted stream to a second reverse osmosis system to remove at least a fourth portion of the organic acids from the pH adjusted stream to form a clean water stream and a second reverse osmosis retentate stream, the second reverse osmosis retentate stream comprising at least the fourth portion of the organic acids.

2. The process of claim 1, wherein adjusting the pH of the first reverse osmosis retentate stream includes adding a basic material to the first reverse osmosis retentate stream to form the pH adjusted stream.

3. The process of claim 2, wherein the pH of the pH adjusted stream is within a range of 6 to 8.

4. The process of claim 2, wherein the basic material is at least one of sodium hydroxide, calcium hydroxide, sodium carbonate, or sodium bicarbonate.

5. The process of claim 1, wherein the clean water stream comprises less than 0.05% of organic acid.

6. The process of claim 1, wherein feeding the membrane feed stream to the membrane system includes feeding the membrane feed stream through the membrane system in a first direction and feeding a water stream through the membrane system in a second direction opposite the first direction.

7. The process of claim 1, further comprising heating the evaporator condensate to a temperature within a range of 70º F to 250º F.

8. A process for purifiying evaporator condensate from an ethanol distillation system, the evaporator condensate comprising water and organic acids, the process comprising:
separating, via a first reverse osmosis system, at least a first portion of the organic acids from the evaporator condensate to form a first reverse osmosis permeate stream and a first reverse osmosis retentate stream, the first reverse osmosis retentate stream comprising the at least the first portion of the organic acids; and
separating, via a second reverse osmosis system, at least a second portion of the organic acids from the first reverse osmosis permeate stream to form a clean water stream and a second reverse osmosis retentate stream, the second reverse osmosis retentate stream comprising the at least the second portion of the organic acids.

9. The process of claim 8, wherein the evaporator condensate further comprises oils, and the process further comprises:
prior to separating the at least the first portion of the organic acids from the evaporator condensate, separating, via a membrane system, at least a third portion of the oils from the evaporator condensate to form a membrane retentate stream comprising the at least the third portion of the oils.

10. The process of claim 8, wherein the evaporator condensate further comprises solids, and the process further comprises:
prior to separating the at least the first portion of the organic acids from the evaporator condensate, separating, via a pre-strainer, at least a third portion of the solids from the evaporator condensate to form a pre-strainer reject stream comprising the at least the third portion of the solids.

11. The process of claim 8, further comprising adjusting a pH of the first reverse osmosis permeate stream by mixing one or more materials with the first reverse osmosis permeate stream.

12. The process of claim 11, wherein the pH of the first reverse osmosis permeate stream is adjusted to a value within a range of 6 to 8.

13. The process of claim 11, wherein adjusting the pH of the first reverse osmosis permeate stream includes forming one or more salts from the organic acids and the one or more materials.

14. The process of claim 8, wherein a first temperature of the first reverse osmosis system and a second temperature of the second reverse osmosis system are each within a range of 70º F to 250º F.

15. A system for purifying evaporator condensate comprising water and organic acids, the system comprising:
a first reverse osmosis system that removes at least a first portion of the organic acids from the evaporator condensate to form a first reverse osmosis permeate stream and a first reverse osmosis retentate stream comprising the at least the first portion of the organic acids; and
a second reverse osmosis system that removes at least a second portion of the organic acids from the first reverse osmosis permeate stream to form a clean water stream and a second reverse osmosis retentate stream comprising the at least the second portion of the organic acids.

16. The system of claim 15, wherein the evaporator condensate further comprises solids, and the system further comprises a pre-strainer that removes at least a third portion of the solids from the evaporator condensate.

17. The system of claim 15, wherein the evaporator condensate further comprises oils, and the system further comprises a membrane system that removes at least a third portion of the oils from the evaporator condensate.

18. The system of claim 17, further comprising:
a water stream flowing through the membrane system in a first direction,
wherein the evaporator condensate flows through the membrane system in a second direction.

19. The system of claim 15, further comprising:
one or more materials configured to adjust a pH of the first reverse osmosis permeate stream to a value within a range of 6 to 8; and
a tank for mixing the first reverse osmosis permeate stream and the one or more materials.

20. The system of claim 19, wherein the one or more materials comprise at least one of sodium hydroxide, calcium hydroxide, sodium carbonate, or sodium bicarbonate.
